(19) United States
(12) Patent Application Publication
(10) Pub. No.: US 2008/0138473 A1
(43) Pub. Date: Jun. 12, 2008

(54) Dual-ovenable food packaging

(76) Inventors: Adam Pawlick, Omaha, NE (US); Doug Czajkowski, Omaha, NE (US)

Correspondence Address: SUITER SWANTZ PC LLO, 14301 FNB PARKWAY, SUITE 220, OMAHA, NE, 68154, US

(21) Appl. No.: 11/636,260

(22) Filed: Dec. 8, 2006

(51) Int. Cl. B65D 81/34; B65B 51/10; B65B 11/02; A23L 1/01; B65B 11/52

(52) U.S. Cl. 426/113; 53/477; 53/463; 53/427; 426/396

(57) ABSTRACT

The present invention is directed to a dual-ovenable food packaging, a method for packaging food and a method for cooking food.

A dual-ovenable food packaging in accordance with the present invention may comprise: (a) a heat-resistant tray; (b) a non-venting plastic film overwrap, and (c) a food items.

A method for packaging food may comprise the steps: (a) disposing a food item in a heat-resistant tray; (b) overwrapping the tray and food item with a non-venting plastic film overwrap; and (c) vacuum sealing the non-venting plastic film overwrap around the heat-resistant tray and food item.

A method for cooking a food item may comprise the steps: (a) disposing a food item in a heat-resistant tray; (b) overwrapping the tray and food item with a plastic film; (c) vacuum sealing the plastic film around the heat-resistant tray and food item to create a sealed packaging; and (d) heating the sealed packaging with a heating device.

### FIELD OF THE INVENTION

The present invention relates generally to a package or container for foods and, more particularly, to a food packaging suitable for cooking of frozen or chilled foods either in a conventional radiant-heat oven or in a microwave oven.

### BACKGROUND OF THE INVENTION

In the food service industry, it is known to package food in containers or packaging adapted for the cooking of the food by heating in either a microwave oven or in a conventional radiant heat oven. Packaging that can withstand exposure to the heating and/or cooking environment of a selected type of oven is said to be “ovenable” with respect to that type of oven. To be ovenable with respect to a microwave oven, the packaging should not, for example, include materials such as metals that reflect microwaves to cause arcing or otherwise damage the oven's microwave generation. To be ovenable with respect to a conventional oven, the packaging should, for example, be able in use to withstand high ambient temperatures for extended periods of time. Packaging that is ovenable with respect to a microwave oven and a conventional oven is “dual-ovenable.”

It has been customary to package food in a container comprising a heat-resistant, molded plastic tray in which the food is contained. The container is then enclosed by a plastic layer sealed around the rim of the tray or by a removable, semi-rigid, pre-formed dome lid. Often the plastic layer or dome lid is comprised of a translucent plastic to provide for the visual display of the product in supermarkets. However such plastics often lack sufficient thermal resistance for use into a microwave or conventional oven and must be removed prior to cooking.

Current packaged meals use one of two cooking technologies to cook a food item. The first technology is conventional convection cooking where heated air surrounds the food. While convection cooking generally produces a cooked product which is evenly cooked and retains its moisture content, such results generally take considerable amounts of time to achieve.

The second technology is steaming where water or other liquid, such as a chicken, beef or vegetable broth, is heated and converted to steam having a temperature sufficient to cook the food. Products which are steamed may also retain their moisture content and may be cooked faster than a conventional oven. However, such cooking mechanisms require that the steaming container be vented so as to maintain pressure equilibrium with respect to the atmosphere to avoid explosive ruptures of the container due to the increase of pressure inside.

As such, cooking in either a conventional oven or microwave generally occurs in an open environment at atmospheric pressure. Such a cooking environment contributes to the dehydration of the food product as evaporated liquids are allowed to escape. In the case of steaming, it also prevents the use of pressure cooking to raise the boiling point of the steaming liquid past its atmospheric boiling point.

Additionally, the extended cooking times for traditional conventional or steam cooking for raw food products tend to have an adverse affect on food product flavor, texture, and appearance. To reduce cook times, food items are commonly pre-cooked and require only reheating prior to consumption. However, these multiple cooking and reheating steps can also have adverse affects on the nutritional value, flavor, texture and appearance of the product.

Therefore, it would be desirable to provide a dual-ovenable food packaging which may be used to cook foods at an elevated pressure, thereby reducing cook times and retaining the moisture content, nutritional value, flavor, texture and appearance of the food.

### SUMMARY OF THE INVENTION

Accordingly, the present invention is directed to a dual-ovenable food packaging and method for its use.

In an embodiment of the invention, a dual-ovenable food packaging may comprise: (a) a heat-resistant tray; (b) a non-venting plastic film overwrap, and (c) one ore more food items.

In a further embodiment of the invention, a method for packaging food may comprise the steps: (a) disposing one or more food items in a heat-resistant tray; (b) overwrapping the tray and food items with a non-venting plastic film; and (c) vacuum sealing the non-venting plastic film around the heat-resistant tray and food items.

In a further embodiment of the invention, a method for cooking food may comprise the steps: (a) disposing one or more food items in a heat-resistant tray; (b) overwrapping the tray and food items with a non-venting plastic film; (c) vacuum sealing the non-venting plastic film around the heat-resistant tray and food items to create a sealed packaging; and (d) heating the sealed packaging with a heating device.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous objects and advantages of the present invention may be better understood by those skilled in the art by reference to the accompanying figures in which:

FIG. 1 depicts an axonometric view of a food packaging in accordance with an embodiment of the present invention;

FIG. 2 depicts a cross-sectional view of a food packaging in accordance with an embodiment of the present invention, wherein a food product is in an uncooked state;

FIG. 3 depicts a cross-sectional view of a food packaging in accordance with an embodiment of the present invention, wherein a food product has been heated;

FIG. 4 depicts a cross-sectional view of a food packaging in accordance with an embodiment of the present invention, wherein a food product is in an uncooked state;

FIG. 5 depicts a cross-sectional view of a food packaging in accordance with an embodiment of the present invention, wherein a food product has been heated;

FIG. 6 depicts an axonometric view of a food packaging in accordance with an embodiment of the present invention;

FIG. 7 depicts a food packaging in accordance with an embodiment of the present invention, wherein the food packaging is to be heated in a microwave or conventional radiant-heat oven.

### DETAILED DESCRIPTION OF THE INVENTION

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Reference will now be made, in detail, to presently preferred embodiments of the invention. Additional details of the invention are provided in the examples illustrated in the accompanying drawings.

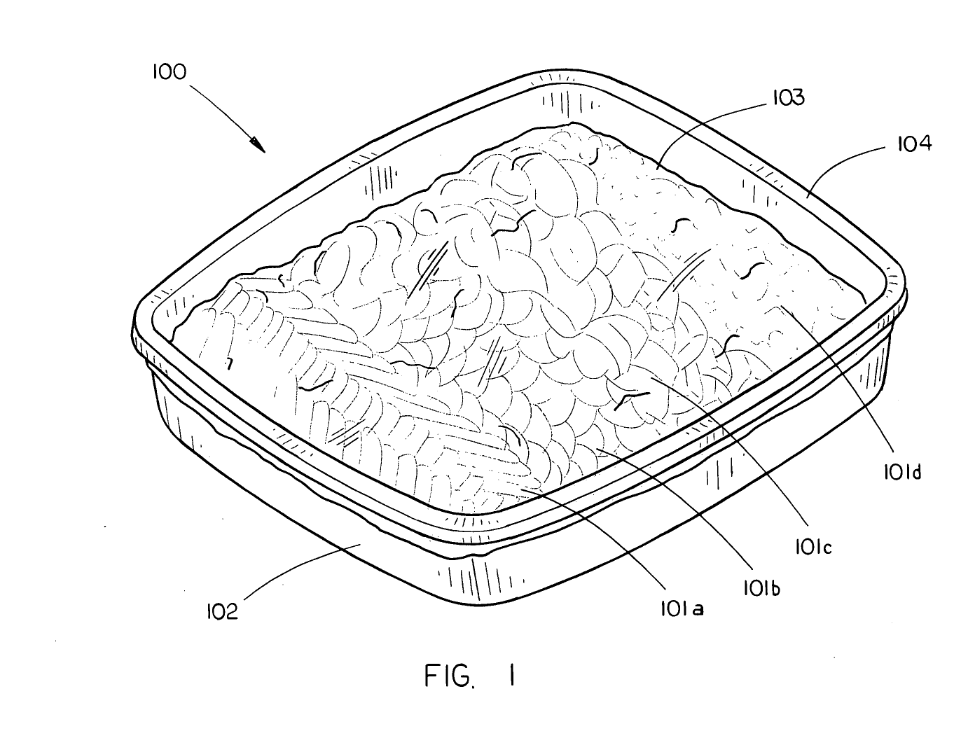

Referring to FIG. 1, an axonometric view of a food packaging 100 in accordance with an embodiment of the present invention is disclosed. One or more food items 101 may be disposed within a heat-resistant plastic tray 102. The food items 101 may be raw or pre-cooked and may be selected from the group comprising: proteins (e.g. fish, shrimp, poultry, beef and pork), starches (e.g. potatoes, pastas and rice), and vegetables (e.g. corn, beans, broccoli, and carrots). The food packaging 100 may be a single-serve composition comprising multiple food item 101 types packaged as a complete meal or a multi-serve composition comprising only one food item 101 type.

The food items 101 may be sealed within the plastic tray 102 by a non-venting plastic overwrap 103. In an embodiment of the invention, the film overwrap 103 may have a bag-like structure where the food items 101 and plastic tray 102 may be completely enclosed by and sealed within the film overwrap 103. In a further embodiment of the invention, the film overwrap 103 may comprise a flat sheet of film which is placed over and heat sealed to the rim 104 of the plastic tray 102.

A non-venting film overwrap 103, in accordance with the invention may comprise a nylon blend having selected physical properties such that it may maintain a closed cooking environment in both microwave and radiant-heat cooking environments. In order to be non-venting, a film overwrap 103 must be capable of maintaining an internal cooking environment within the packaging 100 that remains separated from the ambient environment during the cooking process.

In various embodiments of the invention, the non-venting film overwrap 103 may have one or more of the following properties:
Heat deflection temperature (66 psi): at least 400° F.
Heat deflection temperature (264 psi): at least 160° F.
Melting point: at least 420° F.
Elongation fail percentage: 150-170%

### Such film overwraps may include those produced by the KNF Corporation.

Such properties may enable the film overwrap 103 to expand to a certain degree under heating while maintaining its structural integrity and avoiding rupture. This allows the food packaging 100 to maintain the sealed, non-venting environment in which the temperature and pressure can be increased during the cooking process. Such capabilities may provide for the pressure cooking of the food items 101. Because water's boiling point increases as the surrounding air pressure increases, the pressure built up inside the food packaging allows the liquid in the packaging to rise to a temperature higher than 212° F. before boiling. Most commercial pressure cookers have an internal pressure setting of 15 psi (the standard determined by the USDA). At this pressure water boils at 257° F. The various embodiments of the invention may permit pressures of up to and in excess of this USDA standard. These higher temperatures cause the food items 101 to cook faster thereby reducing cooking times and resulting in a cooked product having increased moisture content and reduced thermal degradation.

In further embodiments of the invention, the amount of pressure and/or steam generated within the packaging 100 can be controlled by varying the thickness of the film overwrap 103, the free water content of the food items 101 and/or the residual air permitted to remain with in the packaging 100 following a vacuum sealing process. The ability to adjust these variables allows for the specification of the cooking environment such that it is particularly suited to a given type of food item 101.

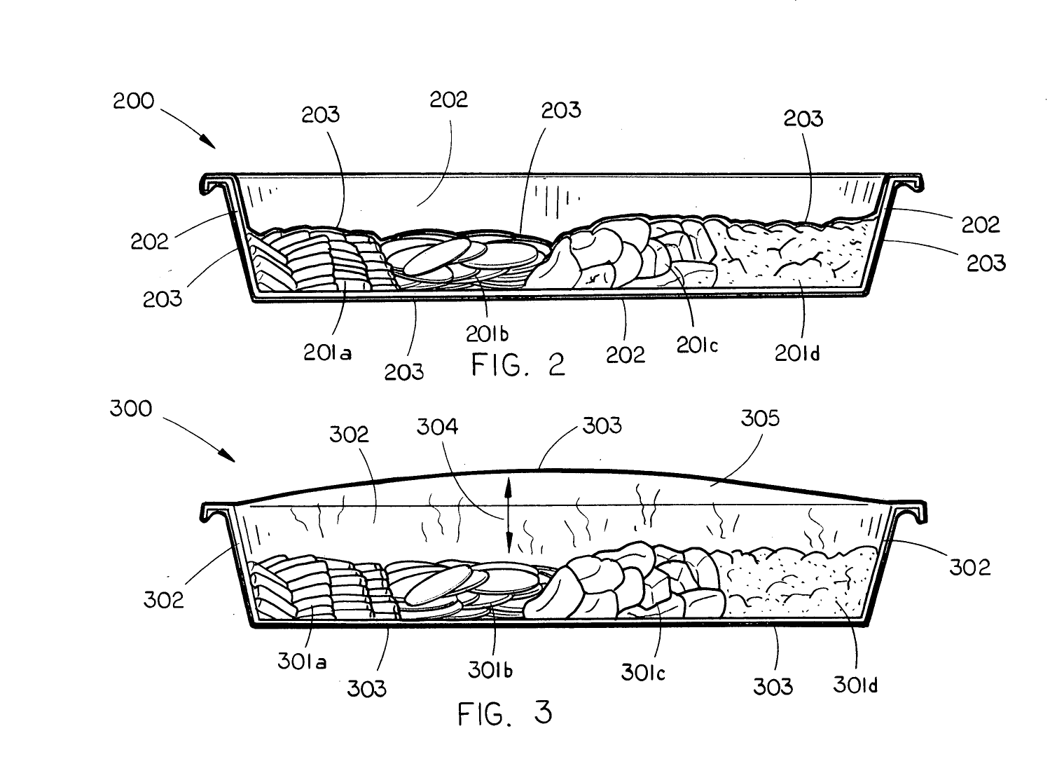

Referring to FIG. 2, a cross-sectional view of a food packaging 200 in accordance with an embodiment of the invention is disclosed. One or more food items 201 may be disposed within a heat-resistant plastic tray 202. The food items 201 may be vacuum-sealed within the plastic tray 202 by a non-venting plastic overwrap 203. The film overwrap 203 may comprise a cook-in-bag which is vacuum-sealed over the food items 201 and plastic tray 202.

Referring to FIG. 3, a cross-sectional view of a food packaging 300 in accordance with an embodiment of the invention is disclosed, wherein the food packaging 300 is subjected to cooking temperatures. One or more food items 301 may be disposed within a heat-resistant plastic tray 302. The food items 301 may be vacuum-sealed within the plastic tray 302 by a non-venting plastic film overwrap 303. The film overwrap 303 may comprise a cook-in-bag which is vacuum-sealed over the food items 301 and the plastic tray 302. Due the non-venting, vacuum-sealed environment maintained within the food packaging 300, applied heat from a cooking device will necessarily result in an increase in pressure. The elastic and heat resistant properties of the film overwrap 303 allow for a slight expansive deformation 304 so as to avoid rupture while maintaining the packaging's pressurized state. Additionally, a portion of the free water contained in the food items may be converted to steam 305. As the pressure within the packaging 300 is elevated due to heating, the steam 305 may become superheated allowing for additional heat-transfer capabilities resulting in faster cooking.

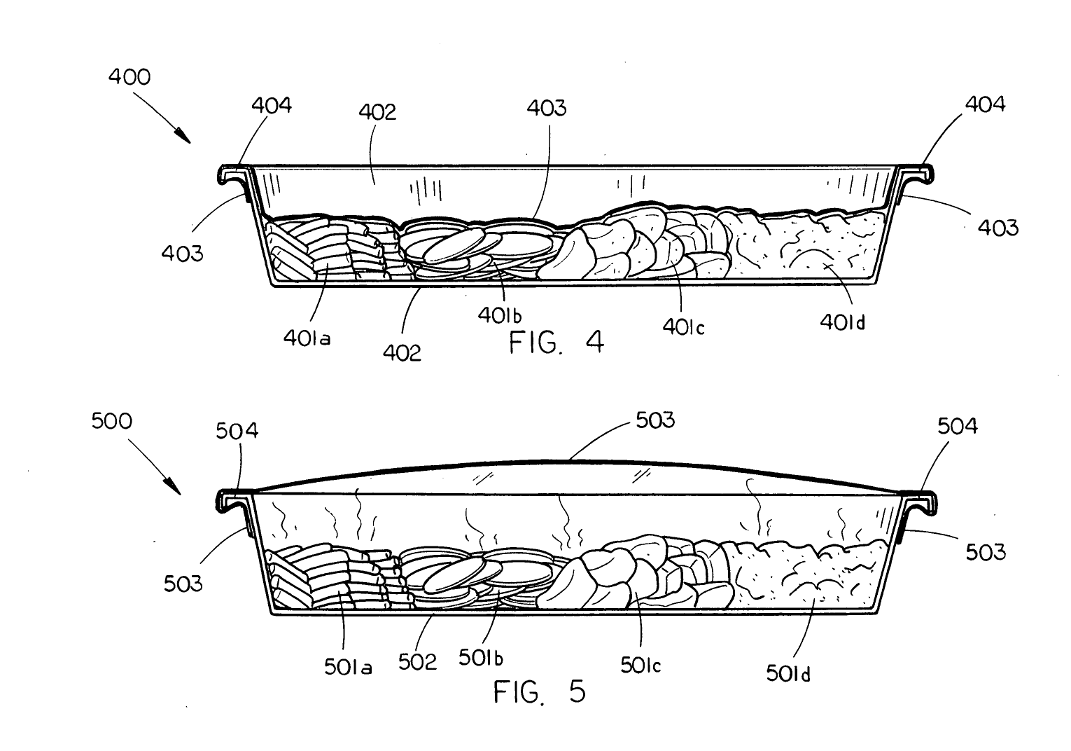

Referring to FIG. 4, a cross-sectional view of a food packaging 400 in accordance with an embodiment of the invention is disclosed. One or more food items 401 may be disposed within a heat-resistant plastic tray 402. The food items 401 may be vacuum-sealed within the plastic tray 402 by a non-venting plastic overwrap 403. The film overwrap 403 may comprise a flat sheet which is vacuum-sealed over the food items 401 and heat sealed to the rim 404 of the plastic tray 402.

Referring to FIG. 5, a cross-sectional view of a food packaging 500 in accordance with an embodiment of the invention is disclosed, wherein the food packaging 500 is subjected to cooking temperatures. One or more food items 501 may be disposed within a heat-resistant plastic tray 502. The food items 501 may be vacuum-sealed within the plastic tray 502 by a non-venting plastic overwrap 503. The film overwrap 503 may comprise a flat sheet which is vacuum-sealed over the food items 501 and heat sealed to the rim 504 of the plastic tray 502. In order to maintain a non-venting cooking environment, the heat seal must be of sufficient strength so as to prevent the film overwrap 503 from separating from the tray rim 504 when subjected to increasing internal pressures during cooking.

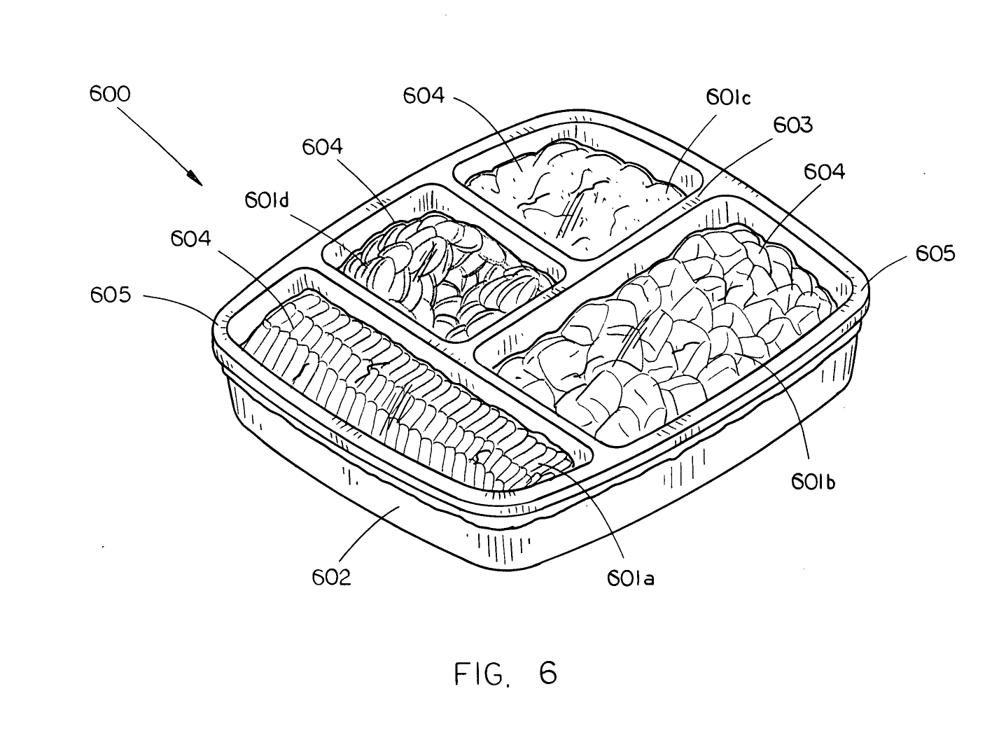

Referring to FIG. 6, an axonometric view of a food packaging 600 in accordance with an embodiment of the present invention is disclosed. One or more distinct food items 601 may be disposed within a heat-resistant plastic tray 602. The heat-resistant plastic tray may further comprise a plurality of partitions 603 which serve to separate the food items 601 into individual portions. The food items 601 may be vacuum-sealed within the plastic tray 602 by a non-venting plastic overwrap 604. In the depicted embodiment of the invention, the film overwrap 604 may comprise a flat sheet which is vacuum-sealed over distinct food items 601 and heat sealed to the rim 605 and partitions 603 of the plastic tray 602. Such a configuration may allow for the free water content of the food items 601 and/or the residual air retained within the packaging 600 following vacuum sealing to be separately established for each distinct food item 601. The ability to adjust these variables allows for the specification of multiple optimal pressure cooking environments such that each is particularly suited to a given type of food item 601.

In further embodiments, the non-venting film overwrap 604 may be disposed only over certain portions (e.g. 601a, 601b) while other portions (e.g. 601c, 601d) may be left exposed to the ambient environment or enclosed by a conventional venting film overwrap. Such a configuration would permit certain food items 601c, 601d which may cook better in an open environment (e.g. breads) to also be included in the packaging.

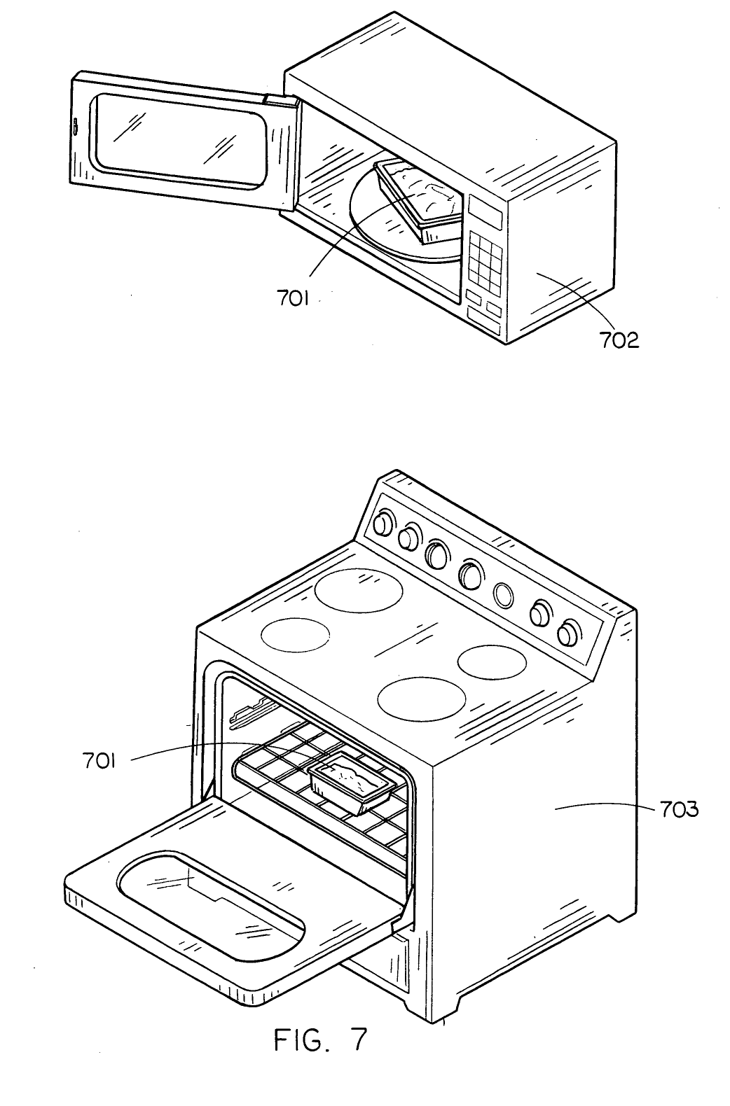

Referring to FIG. 7, a dual-ovenable food packaging in accordance with an embodiment of the present invention is disclosed. The food packaging 701 may be disposed within a microwave oven 702 or a conventional radiant-heat oven 703 for cooking.

It is believed that the present invention and many of its attendant advantages will be understood from the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A food packaging,
the packaging comprising:
a heat-resistant tray;
a non-venting plastic film overwrap; and
one or more food items disposed within the heat-resistant tray.

2. The packaging of claim 1,
wherein the non-venting plastic film overwrap is vacuum-sealed over the heat-resistant tray and food items.

3. The packaging of claim 1,
wherein the non-venting plastic film overwrap comprises a cook-in-bag.

4. The packaging of claim 3,
wherein the heat-resistant tray and food items are disposed within the cook-in-bag.

5. The packaging of claim 1,
wherein the non-venting plastic film overwrap comprises a flat sheet.

6. The packaging of claim 5,
wherein the plastic film sheet is heat sealed to an external rim portion of the heat-resistant tray.

7. The packaging of claim 1,
wherein the packaging is dual-ovenable.

8. The packaging of claim 1,
wherein the heat-resistant tray comprises a plurality of partitions defining a plurality of compartments.

9. The packaging of claim 8,
wherein the non-venting plastic film overwrap is vacuum-sealed over the heat-resistant tray; and
wherein the non-venting plastic film overwrap is heat sealed to an external rim portion of the heat-resistant tray and to the partitions.

10. The packaging of claim 8,
wherein residual air pressure in a free space defined by each compartment and the non-venting plastic film overwrap varies between the compartments.

11. A method for packaging food items,
the method comprising the steps:
disposing a food item in a heat-resistant tray;
overwrapping the heat-resistant tray and food item with a non-venting plastic film overwrap.

12. The method of claim 11,
wherein the non-venting plastic film overwrap comprises a cook-in-bag.

13. The method of claim 11,
wherein the non-venting plastic film overwrap comprises a sheet plastic film.

14. The method of claim 13,
further comprising the step:
heat-sealing the flat sheet to an external rim portion of the heat-resistant tray.

15. The method of claim 11,
further comprising the step:
vacuum-sealing the non-venting plastic film overwrap around the heat-resistant tray and food item.

16. A method for cooking food items,
the method comprising the steps:
disposing a food item in a heat-resistant tray;
overwrapping the heat-resistant tray and food item with a non-venting plastic film overwrap and food item to create a sealed food packaging; and
heating the sealed food packaging in a heating device.

17. The method of claim 16,
further comprising the step:
vacuum sealing the non-venting plastic film overwrap around the heat-resistant tray.

18. The method of claim 16,
wherein the heating device is selected from the group comprising:
a conventional radiant-heat oven; and
a microwave oven.

19. The method of claim 16,
wherein the non-venting plastic film overwrap comprises a cook-in-bag.

20. The method of claim 16,
wherein the non-venting plastic film overwrap comprises a flat sheet.

21. The method of claim 20,
further comprising the step:
heat-sealing the flat sheet to an external rim portion of the heat-resistant tray.
